(19) United States
(12) Patent Application Publication
(10) Pub. No.: US 2024/0414690 A1
(43) Pub. Date: Dec. 12, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventor: Yang LIU, Dongguan (CN)

(73) Assignee: GUANGDONG OPPO MOBILE TELECOMMUNICATIONS CORP., LTD., Dongguan (CN)

(21) Appl. No.: 18/811,520

(22) Filed: Aug. 21, 2024

Related U.S. Application Data
(63) Continuation of application No. PCT/CN2022/077294, filed on Feb. 22, 2022.

(51) Int. Cl. H04W 64/00; H04L 5/00

(52) U.S. Cl. CPC H04W 64/006; H04L 5/0051

(57) ABSTRACT

Embodiments of this application provide a wireless communication method and device, to determine whether there is a line of sight channel between a target device and a target object, and then determine whether the target device may be used as a sensing device of the target object, thereby implementing wireless sensing of the target object. The wireless communication method includes: receiving, by a first device, a first signal, where the first signal is an echo signal formed by reflecting a signal sent by a target device through a target object, and the target device is the first device or the target device is a device other than the first device; and determining, by the first device based on the first signal, whether there is a line of sight between the target device and the target object.

### CROSS-REFERENCE TO RELATED APPLICATIONS

This application is a continuation of International Application No. PCT/CN2022/077294, filed on Feb. 22, 2022, the disclosure of which is hereby incorporated by reference in its entirety.

### TECHNICAL FIELD

Embodiments of this application relate to the communications field, and more specifically, to a wireless communication method and device.

### BACKGROUND

A new radio (NR) system may support a sensing capability, but there must be a line of sight channel with little obstruction/no obstruction between a sensing node and a target object in order to perform wireless sensing. How to determine whether there is a line of sight channel between the sensing node and the target object is an urgent problem to be resolved.

### SUMMARY

Embodiments of this application provide a wireless communication method and device, to determine whether there is a line of sight channel between a target device and a target object.

According to a first aspect, a wireless communication method is provided, and the method includes:
receiving, by a first device, a first signal, where the first signal is an echo signal formed by reflecting a signal sent by a target device through a target object, and the target device is the first device or the target device is a device other than the first device; and
determining, by the first device based on the first signal, whether there is a line of sight between the target device and the target object.

According to a second aspect, a wireless communication method is provided, and the method includes:
receiving, by a first device, a first signal, where the first signal is an echo signal formed by reflecting a signal sent by a target device through a target object, and the target device is the first device or the target device is a device other than the first device; and
generating, by the first device, second information based on the first signal, and sending, by the first device, the second information to a first core network device, where the second information is used by the first core network device to determine whether there is a line of sight between the target device and the target object, or the second information is used by the first core network device to determine whether there is a line of sight propagation path from the target device to the target object and then to the first device, or the second information is used by the first core network device to determine whether the target device is allowed to be a sensing device of the target object.

According to a third aspect, a wireless communication method is provided, and the method includes:
receiving, by a first core network device, target information sent by a first device,
where the target information is used to indicate whether there is a line of sight between a target device and a target object, or the target information is used to indicate whether there is a line of sight propagation path from a target device to a target object and then to the first device, or the target information is used to indicate whether a target device is allowed to be a sensing device of a target object; or
the target information is used by the first core network device to determine whether there is a line of sight between a target device and a target object, or the target information is used by the first core network device to determine whether there is a line of sight propagation path from a target device to a target object and then to the first device, or the target information is used by the first core network device to determine whether a target device is allowed to be a sensing device of a target object,
where the target information is determined based on a first signal, the first signal is an echo signal formed by reflecting a signal sent by the target device through the target object, and the target device is the first device or the target device is a device other than the first device.

According to a fourth aspect, a wireless communications device is provided, configured to execute the method in the first aspect.

Specifically, the wireless communications device includes a function module configured to execute the method in the first aspect.

According to a fifth aspect, a wireless communications device is provided, configured to execute the method in the second aspect.

Specifically, the wireless communications device includes a function module configured to execute the method in the second aspect.

According to a sixth aspect, a core network device is provided, configured to execute the method in the third aspect.

Specifically, the core network device includes a function module configured to execute the method in the third aspect.

According to a seventh aspect, a wireless communications device is provided, including a processor and a memory. The memory is configured to store a computer program, and the processor is configured to invoke and run the computer program stored in the memory, to cause the wireless communications device to execute the method in the first aspect.

According to an eighth aspect, a wireless communications device is provided, including a processor and a memory. The memory is configured to store a computer program, and the processor is configured to invoke and run the computer program stored in the memory, to cause the wireless communications device to execute the method in the second aspect.

According to a ninth aspect, a core network device is provided, including a processor and a memory. The memory is configured to store a computer program, and the processor is configured to invoke and run the computer program stored in the memory, to cause the core network device to execute the method in the third aspect.

According to a tenth aspect, an apparatus is provided, configured to implement the method in any one of the first aspect to the third aspect.

Specifically, the apparatus includes a processor, configured to invoke and run a computer program in a memory, to cause a device installed with the apparatus to execute the method in any one of the first aspect to the third aspect.

According to an eleventh aspect, a computer-readable storage medium is provided, configured to store a computer program. The computer program causes a computer to execute the method in any one of the first aspect to the third aspect.

According to a twelfth aspect, a computer program product is provided, including computer program instructions. The computer program instructions cause a computer to execute the method in any one of the first aspect to the third aspect.

According to a thirteenth aspect, a computer program is provided, and the computer program, when run on a computer, causes the computer to execute the method in any one of the first aspect to the third aspect.

### BRIEF DESCRIPTION OF DRAWINGS

FIG. 1 is a schematic diagram of an architecture of a communications system to which an embodiment of this application is applied.

FIG. 2 is a schematic diagram of a network architecture to which an embodiment of this application is applied.

FIG. 3 is a flowchart of UE-level sensing according to this application.

FIG. 4 is a schematic flowchart of a wireless communication method according to an embodiment of this application.

FIG. 5 is a schematic diagram of a potential sensing node and a sensed object according to an embodiment of this application.

FIG. 6 is a schematic flowchart of another wireless communication method according to an embodiment of this application.

FIG. 7 is a schematic flowchart of still another wireless communication method according to an embodiment of this application.

FIG. 8 is a schematic block diagram of a wireless communications device according to an embodiment of this application.

FIG. 9 is a schematic block diagram of another wireless communications device according to an embodiment of this application.

FIG. 10 is a schematic block diagram of a core network device according to an embodiment of this application.

FIG. 11 is a schematic block diagram of a communications device according to an embodiment of this application.

FIG. 12 is a schematic block diagram of an apparatus according to an embodiment of this application.

FIG. 13 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communication (GSM), a code division multiple access (CDMA) system, a wideband code division multiple access (WCDMA) system, general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), internet of things (IoT), wireless fidelity (WiFi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

In some embodiments, a communications system in embodiments of this application may be applied to a carrier aggregation (CA) scenario, a dual connectivity (DC) scenario, a standalone (SA) networking scenario, or a non-standalone (NSA) networking scenario.

In some embodiments, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

In some embodiments, a communications system in embodiments of this application may be applied to an FR1 frequency band (corresponding to a frequency band range 410 MHz to 7.125 GHZ), or may be applied to an FR2 frequency band (corresponding to a frequency band range 24.25 GHz to 52.6 GHz), or may be applied to a new frequency band, for example, corresponding to a frequency band range 52.6 GHz to 71 GHz, or a high frequency band corresponding to a frequency band range 71 GHz to 114.25 GHz.

Embodiments of this application are described with reference to a network device and a terminal device. The terminal device may also be referred to as user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation system (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, a vehicle-mounted communications device, a wireless communications chip/application specific integrated circuit (ASIC)/system on chip (SoC), or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that only focus on a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional Node B (eNB or eNodeB) in LTE, or a relay station or an access point, or a vehicle-mounted device, a wearable device, a network device or gNB in an NR network, or a network device in a future evolved PLMN, or a network device in an NTN, or the like.

By way of example rather than limitation, in embodiments of this application, the network device may have a mobility characteristic. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, or a high elliptical orbit (HEO) satellite. In some embodiments, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

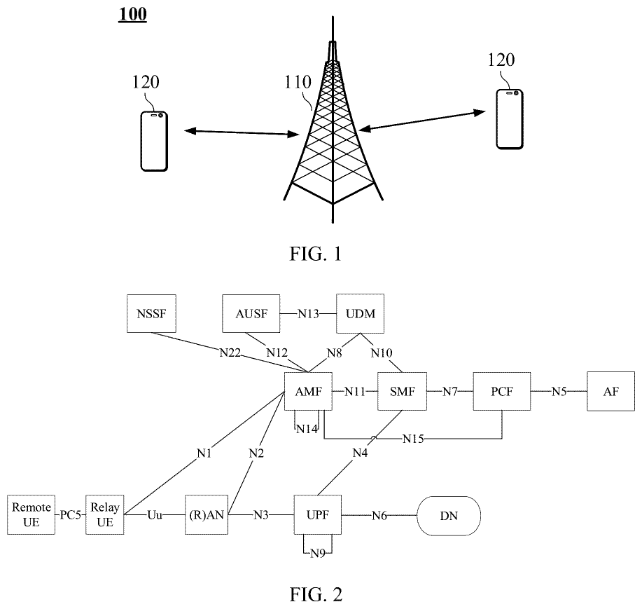

For example, FIG. 1 shows a communications system 100 to which embodiments of this application are applied. The communications system 100 may include a network device 110, and the network device 110 may be a device that communicates with a terminal device 120 (or referred to as a communication terminal or a terminal). The network device 110 may provide communication coverage for a specific geographic area, and may communicate with a terminal device within the coverage area.

FIG. 1 exemplarily shows one network device and two terminal devices. In some embodiments, the communications system 100 may include a plurality of network devices, and another quantity of terminal devices may be included in a coverage range of each network device, which is not limited in embodiments of this application.

In some embodiments, the communications system 100 may further include another network entity such as a network controller or a mobility management entity, which is not limited in embodiments of this application.

It should be understood that in embodiments of this application, a device having a communication function in a network/system may be referred to as a communications device. The communications system 100 shown in FIG. 1 is used as an example. The communications device may include the network device 110 and the terminal device 120 that have a communication function. The network device 110 and the terminal device 120 may be the foregoing specific devices, and details are not described herein again. The communications device may further include another device in the communications system 100, for example, another network entity such as a network controller or a mobility management entity, which is not limited in embodiments of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that this specification relates to a first communications device and a second communications device. The first communications device may be a terminal device, for example, a mobile phone, a machine facility, customer premise equipment (CPE), an industrial device, or a vehicle, and the second communications device may be a peer communications device of the first communications device, for example, a network device, a mobile phone, an industrial device, or a vehicle. In this specification, a specific instance in which the first communications device is a terminal device and the second communications device is a network device is used for description.

The terms used in implementations of this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system. This is not limited in this application.

To facilitate understanding of the technical solutions in embodiments of this application, the following describes the technical solutions in this application in detail by using specific embodiments. The following related technologies, as optional solutions, may be randomly combined with the technical solutions of embodiments of this application, all of which fall within the protection scope of embodiments of this application. Embodiments of this application include at least a part of the following content.

To facilitate understanding of the technical solutions of embodiments of this application, the following describes a network architecture in embodiments of this application.

FIG. 2 is a schematic diagram of a network architecture according to an embodiment of this application. As shown in FIG. 2, a 5G network architecture released by a 3rd Generation Partnership Project (3GPP) standard group includes:
a terminal (user equipment, UE), an access network (radio access network, RAN or access network, AN) supporting a 3GPP technology, a user plane function (UPF) network element, an access and mobility management function (AMF) network element, a session management function (SMF) network element, a policy control function (PCF) network element, an application function (AF), a data network (DN), a network slice selection function (NSSF), an authentication service function (AUSF), and a unified data management function (UDM).

A person skilled in the art may understand that the 5G network architecture shown in FIG. 2 does not constitute a limitation on the 5G network architecture. In specific implementation, the 5G network architecture may include more or fewer network elements than those shown in the figure, or combine some network elements. It should be understood that in FIG. 2, the AN or the RAN is represented in a manner of (R)AN.

The terminal may be user equipment (UE), a handheld terminal, a notebook computer, a subscriber unit, a cellular phone, a smart phone, a wireless data card, a personal digital assistant (PDA) computer, a tablet computer, a wireless modem, a handheld device (handheld), a laptop computer, a cordless phone, a wireless local loop (WLL) station, a machine type communication (MTC) terminal, a handheld device with a wireless communication function, a computing device, a processing device connected to a wireless modem, an unmanned aerial vehicle, a vehicle-mounted device, a wearable device, a terminal in internet of things, a virtual reality device, a terminal device in a future 5G network, a terminal in a future evolved public land mobile network (PLMN), or the like.

An access network device is an access device that is accessed by a terminal to the network architecture in a wireless manner, and is mainly responsible for wireless resource management on an air interface side, quality of service (QOS) management, data compression and encryption, and the like. For example, the access network device is a base station NodeB, an evolved NodeB eNodeB, a base station in a 5G mobile communications system or a new radio (NR) communications system, or a base station in a future mobile communications system.

The UPF network element, the AMF network element, the SMF network element, and the PCF network element are network elements of a 3GPP core network (core network elements for short). The UPF network element may be referred to as a user plane function network element, and is mainly responsible for user data transmission. Other network elements may be referred to as control plane function network elements, and are mainly responsible for certification, authentication, registration management, session management, mobility management, policy control, and the like, so as to ensure reliable and stable user data transmission.

The UPF network element may be configured to forward and receive data of a terminal. For example, the UPF network element may receive service data from a data network, and transmit the service data to the terminal through an access network device. The UPF network element may further receive user data from the terminal through the access network device, and forward the user data to the data network. Transmission resources allocated and scheduled by the UPF network element to the terminal are managed and controlled by the SMF network element. A bearer between the terminal and the UPF network element may include: a user plane connection between the UPF network element and the access network device, and a channel established between the access network device and the terminal. The user plane connection is a quality of service (QOS) flow that may be established between the UPF network element and the access network device for data transmission.

The AMF network element may be configured to manage access of a terminal to a core network, for example, a location update of the terminal, network registration, access control, mobility management of the terminal, and attachment and detachment of the terminal. In a case of providing a service for a session of the terminal, the AMF network element may further provide storage resources of a control plane for the session, so as to store a session identifier, an SMF network element identifier associated with the session identifier, and the like.

The SMF network element may be configured to: select a user plane network element for a terminal, redirect a user plane network element for the terminal, allocate an internet protocol (IP) address to the terminal, establish a bearer (also referred to as a session) between the terminal and the UPF network element, modify and release a session, and control QoS.

The PCF network element is configured to provide a policy for the AMF network element and the SMF network element, for example, a QoS policy or a slice selection policy.

The AF network element is configured to: interact with a network element in the 3GPP core network to support routing of data transmission at an application layer, access a network exposure function, and interact with the PCF network element for policy control, and the like.

The DN, for example, an IP multi-media service (IMS) network or the Internet, may provide a data service for a user. There may be a plurality of application servers (AS) in the DN to provide different application services, such as an operator service, an Internet access service, or a third-party service. The AS may implement a function of the AF.

The NSSF is configured to select a network slice, and supported functions include, for example, selecting a network slice instance set that serves UE; determining allowed network slice selection assistance information (NSSAI), and determining a mapping to subscribed single-network slice selection assistance information (S-NSSAI) when required; determining configured NSSAI, and determining a mapping to subscribed S-NSSAI when required; and determining an AMF set that may be used to query UE, or determining a list of candidate AMFs based on a configuration.

The AUSF is configured to: receive an identity authentication request for a terminal from the AMF, request a key from the UDM, and then forward the delivered key to the AMF for authentication processing.

The UDM includes functions such as generation and storage of user subscription data, and authentication data management, and supports interaction with an external third-party server.

In FIG. 2, each network element may be a network component in a hardware device, a software function running on dedicated hardware, or a virtualized function instantiated on a platform (for example, a cloud platform). It should be noted that, in the network architecture shown in FIG. 2, network elements included in the entire network architecture are merely described by using an example. In embodiments of this application, network elements included in the entire network architecture are not limited.

To facilitate understanding of the technical solutions in embodiments of this application, the following describes wireless sensing related to this application.

A cellular network (including a 5G network) is merely used for communication. However, actually, a wireless electromagnetic wave signal used in the cellular network can not only be used for wireless data transmission and communication, but also have an environment sensing capability, for example, motion or gesture recognition of a user, respiration monitoring, measurement of a moving speed of a terminal, environment imaging, and weather monitoring. Therefore, a future cellular network may consider not only for communication and data transmission, but also for acquisition of sensing information.

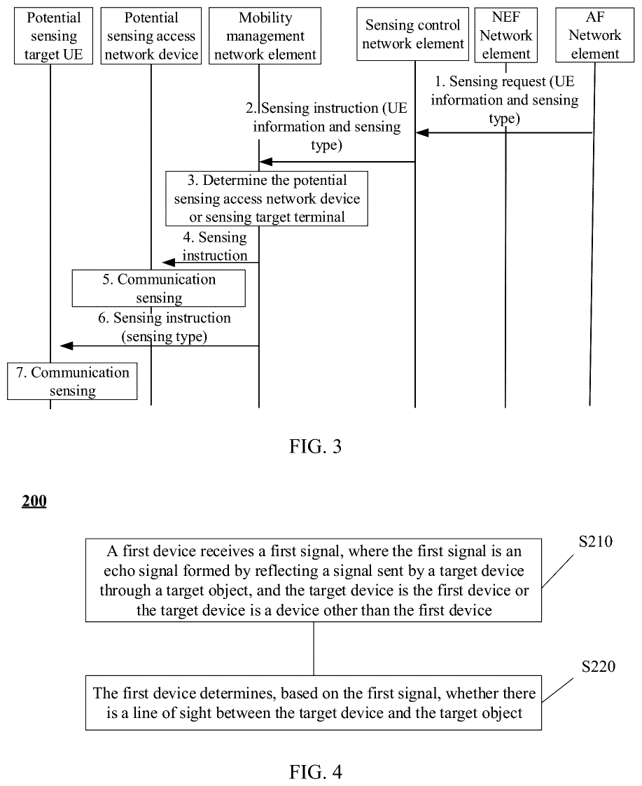

A sensing capability is supported in a beyond 5G (BB5G) network, and a sensing function is supported in a 3GPP network by adding a sensing control network element (Sensing Function) and a corresponding procedure. As shown in FIG. 3, FIG. 3 is a possible flowchart of controlling an access network device or UE to perform a UE-level sensing operation. When an application function (AF) network element sends a sensing request for target UE/a target object to a core network of a 3GPP network by using a network exposure function (NEF) network element, the core network selects a proper access network device or auxiliary UE by using a sensing control network element or an AMF, triggers a capability of performing sensing-related wireless measurement, starts measurement of sensing information, and generates a sensing result.

In some embodiments, main wireless sensing scenarios of integrated sensing and communication are as follows.

(1) Base station echo sensing link: A base station sends a sensing signal and receives an echo signal.

(2) Inter-base station sensing link: A base station B receives a sensing signal sent by a base station A.

(3) Air interface sensing uplink: A base station receives a sensing signal sent by a terminal.

(4) Air interface sensing downlink: A terminal receives a sensing signal sent by a base station.

(5) Terminal echo sensing link: A terminal sends a sensing signal and receives an echo signal.

(6) Inter-terminal sensing link: A terminal B receives a sensing signal sent by a terminal A.

In an initial stage of integrated sensing and communication in B5G, it is considered to perform a sensing action by reusing existing air interface signals as much as possible, without introducing excessive air interface enhancement.

To facilitate understanding of the technical solutions in embodiments of this application, the following describes a line of sight (LOS) or a non-line of sight (NLOS) related to this application.

Line-of-sight propagation refers to propagation of an electromagnetic ray along a straight line. A ray or wave deviates from an original path or is reflected when an obstruction is encountered, and cannot continue to propagate along a horizontal line or around the obstruction. In a communications system, a receiver performs channel estimation on a received signal, and identifies an NLOS/LOS propagation scenario by inputting channel characteristic quantities (for example, a delay spread (DS), an angular spread (AS), a K factor (K factor), and a path loss) that are obtained through the channel estimation to a specific mathematical model.

To facilitate understanding of the technical solutions in embodiments of this application, the following describes the problems to be resolved in this application.

There must be a line of sight channel with little obstruction/no obstruction between a sensing node and a target in order to perform wireless sensing. How to determine whether there is a line of sight channel with little obstruction/no obstruction between a potential sensing node and a target object and how to select a qualified sensing node are problems that need to be resolved.

Based on the foregoing technical problems, this application proposes a sensing solution, to determine whether there is a line of sight channel between a target device and a target object, and then determine whether the target device may be used as a sensing device of the target object, thereby implementing wireless sensing of the target object.

The following describes the technical solutions of this application in detail by using specific embodiments.

FIG. 4 is a schematic flowchart of a wireless communication method 200 according to an embodiment of this application. As shown in FIG. 4, the wireless communication method 200 may include at least a part of following content.

S210. A first device receives a first signal, where the first signal is an echo signal formed by reflecting a signal sent by a target device through a target object, and the target device is the first device or the target device is a device other than the first device.

S220. The first device determines, based on the first signal, whether there is a line of sight between the target device and the target object.

In embodiments of this application, the first signal is an echo signal formed by reflecting the signal sent by the target device through the target object. In addition, the echo signal may further include a signal formed by scattering or diffracting the signal sent by the target device through the target object. This is not limited in this application.

Features such as a shape and a size of the target object are not limited in embodiments of this application. In addition, a type of the signal sent by the target device is not limited in embodiments of this application.

In embodiments of this application, the target device may be a potential sensing node of a target object. After it is determined whether there is a line of sight channel between the target device and the target object, it may be determined whether the target device may be used as a sensing device of the target object, thereby implementing wireless sensing of the target object. Specifically, for example, in a case that there is a line of sight channel between the target device and the target object, the target device may be used as a sensing device of the target object. In a case that there is no line of sight channel between the target device and the target object, the target device cannot be used as a sensing device of the target object.

In some embodiments, the target device is the first device (the first device performs sending and receiving by itself), that is, the first device determines, based on an echo signal formed by reflecting a signal sent by the first device through the target object, whether there is a line of sight between the first device and the target object.

In some embodiments, the target device is a device other than the first device (another device performs sending and the first device performs receiving), that is, the first device determines, based on an echo signal formed by reflecting the signal sent by the target device through the target object, whether there is a line of sight between the target device and the target object. In other words, the first device assists the target device to determine whether there is a line of sight between the target device and the target object.

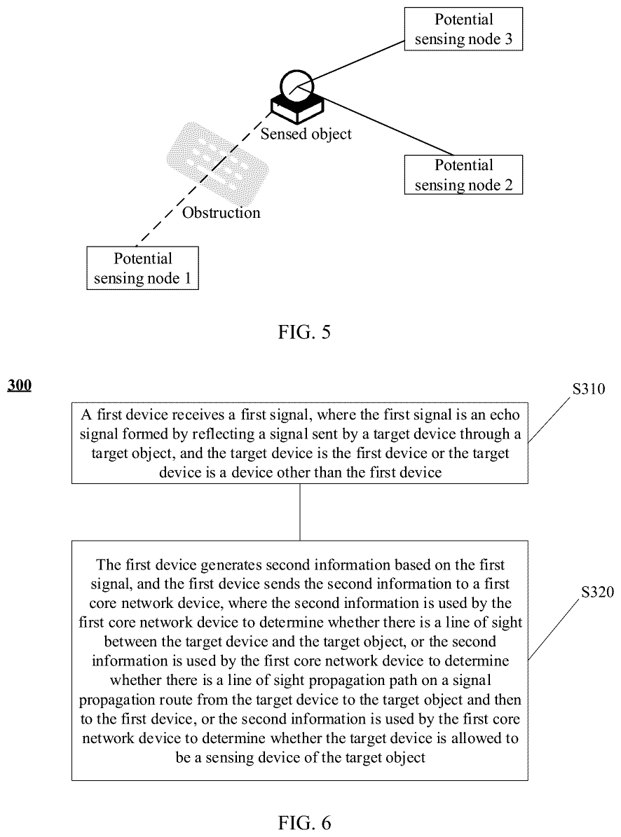

Specifically, for example, as shown in FIG. 5, there is an obstruction between a potential sensing node 1 and a sensed object, and there is no obstruction between the sensed object and other potential sensing nodes (a potential sensing node 2 and a potential sensing node 3). When the potential sensing node 1 sends a signal, due to the presence of the obstruction, after the potential sensing node 2 and the potential sensing node 3 perform channel estimation on the received signal, it may be discovered that there is wireless propagation of a non-line of sight. In this case, the potential sensing node 1 may be the target device, and the potential sensing node 2 is the first device, or the potential sensing node 3 is the first device.

As shown in FIG. 5, when the potential sensing node 2 and the potential sensing node 3 sense each other, it may be discovered that there is wireless propagation of a line of sight. Specifically, when the potential sensing node 2 sends a signal, after the potential sensing node 3 performs channel estimation on the received signal, it may be discovered that there is wireless propagation of a line of sight; or when the potential sensing node 3 sends a signal, after the potential sensing node 2 performs channel estimation on the received signal, it may be discovered that there is wireless propagation of a line of sight.

In some embodiments, the first device is a terminal device, or the first device is a base station (also referred to as an access network device). Certainly, the first device may be alternatively another device. This is not limited in this application.

In some embodiments, the target device is a terminal device, or the target device is a base station (also referred to as an access network device). Certainly, the target device may be alternatively another device. This is not limited in this application.

In some embodiments, the first device sends first information to a first core network device. The first information is used to indicate whether there is a line of sight between the target device and the target object, or the first information is used to indicate whether there is a line of sight propagation path on a signal propagation route from the target device to the target object and then to the first device, or the first information is used to indicate whether the target device is allowed to be a sensing device of the target object.

In some embodiments, the first information includes but is not limited to at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

It should be noted that the identity information of the first device may be an identity (ID) of the first device, or may be an index of the first device, or other information used to identify the first device. This is not limited in this application. Similarly, the identity information of the target device may be an identity (ID) of the target device, or may be an index of the target device, or other information used to identify the target device. This is not limited in this application. The identity information of the signal sent by the target device may be, for example, a sequence ID used by a reference signal sent by the target device.

In some embodiments, the first core network device is an AMF network element, or the first core network device is a sensing control network element. Certainly, the first core network device may be alternatively another device. This is not limited in this application.

In some embodiments, the signal sent by the target device is sent by the target device based on information about an angle between the target device and the target object. Specifically, for example, the target device sends the signal based on the information about the angle between the target device and the target object.

In some embodiments, the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device.

In some embodiments, a configuration of the reference signal sent by the target device is indicated by the first core network device, or a configuration of the reference signal sent by the target object is indicated by the first core network device. For example, the target device sends the reference signal based on configuration information indicated by the first core network device. For another example, the target object sends the reference signal based on configuration information indicated by the first core network device.

Specifically, in a case that the information about the angle between the target device and the target object is determined based on measurement performed by the target object on the reference signal sent by the target device, the target object may send the information about the angle between the target device and the target object to the target device. In this case, the target object may be an electronic device.

In Embodiment 1, the foregoing S220 may specifically include:
generating, by the first device, a distance-speed domain matrix based on the first signal; and
determining, by the first device based on the distance-speed domain matrix and a distance between the target device and the target object, whether there is a line of sight between the target device and the target object.

In some implementations of Embodiment 1, in a case that there is an element whose value is greater than a first threshold in an element corresponding to a first distance in the distance-speed domain matrix, the first device determines that there is a line of sight between the target device and the target object; and/or in a case that there is no element whose value is greater than a first threshold in an element corresponding to a first distance in the distance-speed domain matrix, the first device determines that there is no line of sight between the target device and the target object.

It should be noted that an element corresponding to a first distance in the distance-speed domain matrix may be understood as follows: an element of each row/column in the distance-speed domain matrix corresponds to a first distance.

In some implementations, the first distance is the distance between the target device and the target object, or the first distance is a sum of the distance between the target device and the target object and a preset error value, or the first distance is a difference between the distance between the target device and the target object and a preset error value.

In some implementations, the first threshold is a fixed value, or the first threshold is preconfigured, or the first threshold is configured by a network device. Optionally, the network device may be a base station or a core network device.

In some implementations, the preset error value is a fixed value, or the preset error value is preconfigured, or the preset error value is configured by a network device. Optionally, the network device may be a base station or a core network device.

In Embodiment 2, the foregoing S220 may specifically include:
generating, by the first device, channel response information based on the first signal; and
determining, by the first device based on the channel response information and a distance between the target device and the target object, whether there is a line of sight between the target device and the target object.

In some implementations of Embodiment 2, in a case that a channel response absolute value corresponding to a first distance in the channel response information is greater than a second threshold, the first device determines that there is a line of sight between the target device and the target object; and/or in a case that a channel response absolute value corresponding to a first distance in the channel response information is less than or equal to a second threshold, the first device determines that there is no line of sight between the target device and the target object.

It should be noted that a channel response absolute value corresponding to a first distance in the channel response information may be understood as follows: each channel response absolute value in the channel response information corresponds to a first distance.

In some implementations, the first distance is the distance between the target device and the target object, or the first distance is a sum of the distance between the target device and the target object and a preset error value, or the first distance is a difference between the distance between the target device and the target object and a preset error value.

In some implementations, the second threshold is a fixed value, or the second threshold is preconfigured, or the second threshold is configured by a network device. Optionally, the network device may be a base station or a core network device.

In Embodiment 3, in a case that the target device is a device other than the first device, the foregoing S220 may specifically include:
determining, by the first device based on the first signal, whether there is a line of sight propagation path on a signal propagation route from the target device to the target object and then to the first device.

In some implementations of Embodiment 3, the first device generates a distance-speed domain matrix based on the first signal; and
the first device determines, based on the distance-speed domain matrix, a distance between the target device and the target object, and a distance between the first device and the target object, whether there is a line of sight propagation path on the signal propagation route from the target device to the target object and then to the first device.

In some implementations, in a case that there is an element whose value is greater than a third threshold in an element corresponding to a second distance in the distance-speed domain matrix, the first device determines that there is a line of sight propagation path on the signal propagation route from the target device to the target object and then to the first device; and/or in a case that there is no element whose value is greater than a third threshold in an element corresponding to a second distance in the distance-speed domain matrix, the first device determines that there is no line of sight propagation path on the signal propagation route from the target device to the target object and then to the first device.

In some implementations, the second distance is a sum of D₁ and D₂, or the second distance is a sum of D₁, D₂, and a preset error value, or the second distance is a difference between a sum of D₁ and D₂ and a preset error value, where D₁ represents the distance between the target device and the target object, and D₂ represents the distance between the first device and the target object.

In some implementations, the third threshold is a fixed value, or the third threshold is preconfigured, or the third threshold is configured by a network device. Optionally, the network device may be a base station or a core network device.

In some implementations of Embodiment 3, the first device generates channel response information based on the first signal; and
the first device determines, based on the channel response information, a distance between the target device and the target object, and a distance between the first device and the target object, whether there is a line of sight propagation path on the signal propagation route from the target device to the target object and then to the first device.

In some implementations, in a case that a channel response value corresponding to a second distance in the channel response information is greater than a fourth threshold, the first device determines that there is a line of sight propagation path on the signal propagation route from the target device to the target object and then to the first device; and/or in a case that a channel response value corresponding to a second distance in the channel response information is less than or equal to a fourth threshold, the first device determines that there is no line of sight propagation path on the signal propagation route from the target device to the target object and then to the first device.

In some implementations, the second distance is a sum of D₁ and D₂, or the second distance is a sum of D₁, D₂, and a preset error value, or the second distance is a difference between a sum of D₁ and D₂ and a preset error value, where D₁ represents the distance between the target device and the target object, and D₂ represents the distance between the first device and the target object.

In some implementations, the fourth threshold is a fixed value, or the fourth threshold is preconfigured, or the fourth threshold is configured by a network device. Optionally, the network device may be a base station or a core network device.

In some embodiments, the distance between the target device and the target object is determined by the first device based on location information of the target device and location information of the target object, or the distance between the target device and the target object is indicated by a first core network device to the first device, or the distance between the target device and the target object is determined based on measurement performed by the target device on a reference signal sent by the target object, or the distance between the target device and the target object is determined based on measurement performed by the target object on a reference signal sent by the target device.

In some embodiments, the location information of the target device and the location information of the target object are indicated by the first core network device to the first device.

In some embodiments, the distance between the first device and the target object is determined by the first device based on location information of the first device and location information of the target object, or the distance between the first device and the target object is indicated by a first core network device to the first device, or information about the distance between the first device and the target object is determined based on measurement performed by the first device on a reference signal sent by the target object, or information about the distance between the first device and the target object is determined based on measurement performed by the target object on a reference signal sent by the first device.

In some embodiments, the location information of the first device and the location information of the target object are indicated by the first core network device to the first device.

In some embodiments, a configuration of the reference signal sent by the target device is indicated by the first core network device, or a configuration of the reference signal sent by the first device is indicated by the first core network device, or a configuration of the reference signal sent by the target object is indicated by the first core network device. For example, the target device sends the reference signal based on configuration information indicated by the first core network device. For another example, the target object sends the reference signal based on configuration information indicated by the first core network device. For another example, the first device sends the reference signal based on configuration information indicated by the first core network device.

Therefore, in this embodiment of this application, a first device may determine, based on an echo signal formed by reflecting a signal sent by a target device through a target object, whether there is a line of sight between the target device and the target object, and then determine whether the target device may be used as a sensing device of the target object, thereby implementing wireless sensing of the target object.

FIG. 6 is a schematic flowchart of a wireless communication method 300 according to an embodiment of this application. As shown in FIG. 6, the wireless communication method 300 may include at least a part of following content.

S310. A first device receives a first signal, where the first signal is an echo signal formed by reflecting a signal sent by a target device through a target object, and the target device is the first device or the target device is a device other than the first device.

S320. The first device generates second information based on the first signal, and the first device sends the second information to a first core network device, where the second information is used by the first core network device to determine whether there is a line of sight between the target device and the target object, or the second information is used by the first core network device to determine whether there is a line of sight propagation path on a signal propagation route from the target device to the target object and then to the first device, or the second information is used by the first core network device to determine whether the target device is allowed to be a sensing device of the target object.

In embodiments of this application, the first signal is an echo signal formed by reflecting the signal sent by the target device through the target object. In addition, the echo signal may further include a signal formed by scattering or diffracting the signal sent by the target device through the target object. This is not limited in this application.

Features such as a shape and a size of the target object are not limited in embodiments of this application. In addition, a type of the signal sent by the target device is not limited in embodiments of this application.

In embodiments of this application, the target device may be a potential sensing node of a target object. After it is determined whether there is a line of sight channel between the target device and the target object, it may be determined whether the target device may be used as a sensing device of the target object, thereby implementing wireless sensing of the target object. Specifically, for example, in a case that there is a line of sight channel between the target device and the target object, the target device may be used as a sensing device of the target object. In a case that there is no line of sight channel between the target device and the target object, the target device cannot be used as a sensing device of the target object.

In some embodiments, the target device is the first device (the first device performs sending and receiving by itself), that is, the first device determines, based on an echo signal formed by reflecting a signal sent by the first device through the target object, whether there is a line of sight between the first device and the target object.

In some embodiments, the target device is a device other than the first device (another device performs sending and the first device performs receiving), that is, the first device determines, based on an echo signal formed by reflecting the signal sent by the target device through the target object, whether there is a line of sight between the target device and the target object. In other words, the first device assists the target device to determine whether there is a line of sight between the target device and the target object.

In some embodiments, the first device is a terminal device, or the first device is a base station (also referred to as an access network device). Certainly, the first device may be alternatively another device. This is not limited in this application.

In some embodiments, the target device is a terminal device, or the target device is a base station (also referred to as an access network device). Certainly, the target device may be alternatively another device. This is not limited in this application.

In some embodiments, the first core network device is an AMF network element, or the first core network device is a sensing control network element. Certainly, the first core network device may be alternatively another device. This is not limited in this application.

In some embodiments, the second information includes first channel information, and the first channel information includes but is not limited to at least one of following: a delay spread (DS), an angular spread (AS), a K factor (K factor), or a path loss (path loss).

In some embodiments, the second information is not limited to at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

In some embodiments, the signal sent by the target device is sent by the target device based on information about an angle between the target device and the target object.

In some embodiments, the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device.

In some embodiments, a configuration of the reference signal sent by the target device is indicated by the first core network device, or a configuration of the reference signal sent by the target object is indicated by the first core network device. For example, the target device sends the reference signal based on configuration information indicated by the first core network device. For another example, the target object sends the reference signal based on configuration information indicated by the first core network device.

Therefore, in this embodiment of this application, a first device may generate second information based on an echo signal formed by reflecting a signal sent by a target device through a target object, and send the second information to a first core network device, so that the first core network device may determine, based on the second information, whether there is a line of sight between the target device and the target object, or determine whether there is a line of sight propagation path from the target device to the target object and then to the first device, and then determine whether the target device is allowed to be a sensing device of the target object, thereby implementing wireless sensing of the target object.

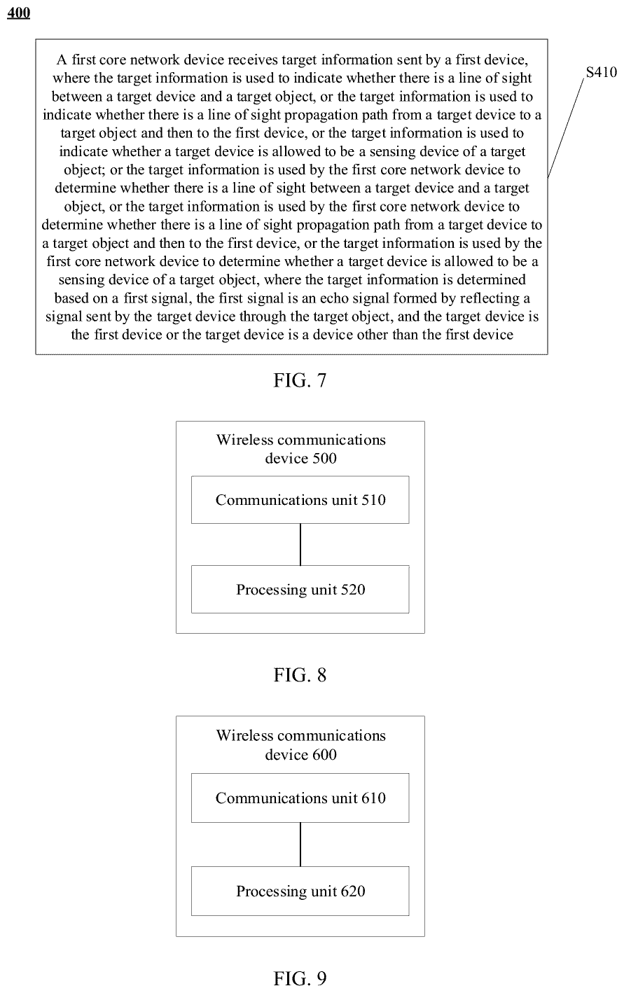

The foregoing describes in detail the embodiments on the side of the first device in this application with reference to FIG. 4 to FIG. 6. The following describes in detail the embodiment on the side of the first core network device in this application with reference to FIG. 7. It should be understood that the embodiment on the side of the first core network device corresponds to the embodiments on the side of the first device. For similar descriptions, refer to the embodiments on the side of the first device.

FIG. 7 is a schematic flowchart of a wireless communication method 400 according to an embodiment of this application. As shown in FIG. 7, the wireless communication method 400 may include at least a part of following content.

S410. A first core network device receives target information sent by a first device, where the target information is used to indicate whether there is a line of sight between a target device and a target object, or the target information is used to indicate whether there is a line of sight propagation path from a target device to a target object and then to the first device, or the target information is used to indicate whether a target device is allowed to be a sensing device of a target object; or the target information is used by the first core network device to determine whether there is a line of sight between a target device and a target object, or the target information is used by the first core network device to determine whether there is a line of sight propagation path from a target device to a target object and then to the first device, or the target information is used by the first core network device to determine whether a target device is allowed to be a sensing device of a target object, where the target information is determined based on a first signal, the first signal is an echo signal formed by reflecting a signal sent by the target device through the target object, and the target device is the first device or the target device is a device other than the first device.

In embodiments of this application, the first signal is an echo signal formed by reflecting the signal sent by the target device through the target object. In addition, the echo signal may further include a signal formed by scattering or diffracting the signal sent by the target device through the target object. This is not limited in this application.

Features such as a shape and a size of the target object are not limited in embodiments of this application. In addition, a type of the signal sent by the target device is not limited in embodiments of this application.

In embodiments of this application, the target device may be a potential sensing node of the target object. After it is determined whether there is a line of sight channel between the target device and the target object, it may be determined whether the target device may be used as a sensing device of the target object, thereby implementing wireless sensing of the target object. Specifically, for example, in a case that there is a line of sight channel between the target device and the target object, the target device may be used as a sensing device of the target object. In a case that there is no line of sight channel between the target device and the target object, the target device cannot be used as a sensing device of the target object.

In some embodiments, the target device is the first device (the first device performs sending and receiving by itself), that is, the first device determines, based on an echo signal formed by reflecting a signal sent by the first device through the target object, whether there is a line of sight between the first device and the target object.

In some embodiments, the target device is a device other than the first device (another device performs sending and the first device performs receiving), that is, the first device determines, based on an echo signal formed by reflecting the signal sent by the target device through the target object, whether there is a line of sight between the target device and the target object. In other words, the first device assists the target device to determine whether there is a line of sight between the target device and the target object.

In some embodiments, the first device is a terminal device, or the first device is a base station (also referred to as an access network device). Certainly, the first device may be alternatively another device. This is not limited in this application.

In some embodiments, the target device is a terminal device, or the target device is a base station (also referred to as an access network device). Certainly, the target device may be alternatively another device. This is not limited in this application.

In some embodiments, the first core network device is an AMF network element, or the first core network device is a sensing control network element. Certainly, the first core network device may be alternatively another device. This is not limited in this application.

In some embodiments, the target information includes first channel information, and the first channel information includes but is not limited to at least one of following: a delay spread (DS), an angular spread (AS), a K factor (K factor), or a path loss (path loss).

In some embodiments, the target information includes but is not limited to at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

In some embodiments, the first core network device determines, based on the target information, whether there is a line of sight between the target device and the target object, or the first core network device determines, based on the target information, whether there is a line of sight propagation path from the target device to the target object and then to the first device, or the first core network device determines, based on the target information, whether the target device is allowed to be a sensing device of the target object.

In some embodiments, the signal sent by the target device is sent by the target device based on information about an angle between the target device and the target object.

In some embodiments, the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device.

In some embodiments, a configuration of the reference signal sent by the target device is indicated by the first core network device, or a configuration of the reference signal sent by the target object is indicated by the first core network device. For example, the target device sends the reference signal based on configuration information indicated by the first core network device. For another example, the target object sends the reference signal based on configuration information indicated by the first core network device.

Therefore, in this embodiment of this application, a first core network device receives target information sent by a first device, and the first core network device may determine, based on the target information, whether there is a line of sight between a target device and a target object, or determine whether there is a line of sight propagation path from a target device to a target object and then to the first device, and then determine whether the target device is allowed to be a sensing device of the target object, thereby implementing wireless sensing of the target object.

The foregoing describes the method embodiments of this application in detail with reference to FIG. 4 to FIG. 7. The following describes the apparatus embodiments of this application in detail with reference to FIG. 8 to FIG. 10. It should be understood that the apparatus embodiments are corresponding to the method embodiments. For similar descriptions, refer to the method embodiments.

FIG. 8 is a schematic block diagram of a wireless communications device 500 according to an embodiment of this application. The wireless communications device 500 is a first device. As shown in FIG. 8, the wireless communications device 500 includes:
a communications unit 510, configured to receive a first signal, where the first signal is an echo signal formed by reflecting a signal sent by a target device through a target object, and the target device is the first device or the target device is a device other than the first device; and
a processing unit 520, configured to determine, based on the first signal, whether there is a line of sight between the target device and the target object.

In some embodiments, the processing unit 520 is specifically configured to:
generate a distance-speed domain matrix based on the first signal; and
determine, based on the distance-speed domain matrix and a distance between the target device and the target object, whether there is a line of sight between the target device and the target object.

In some embodiments, the processing unit 520 is specifically configured to:
in a case that there is an element whose value is greater than a first threshold in an element corresponding to a first distance in the distance-speed domain matrix, determine that there is a line of sight between the target device and the target object; and/or
in a case that there is no element whose value is greater than a first threshold in an element corresponding to a first distance in the distance-speed domain matrix, determine that there is no line of sight between the target device and the target object.

The first distance is the distance between the target device and the target object, or the first distance is a sum of the distance between the target device and the target object and a preset error value, or the first distance is a difference between the distance between the target device and the target object and a preset error value.

In some embodiments, the first threshold is a fixed value, or the first threshold is preconfigured, or the first threshold is configured by a network device.

In some embodiments, the processing unit 520 is specifically configured to:
generate channel response information based on the first signal; and
determine, based on the channel response information and a distance between the target device and the target object, whether there is a line of sight between the target device and the target object.

In some embodiments, the processing unit 520 is specifically configured to:
in a case that a channel response absolute value corresponding to a first distance in the channel response information is greater than a second threshold, determine that there is a line of sight between the target device and the target object; and/or
in a case that a channel response absolute value corresponding to a first distance in the channel response information is less than or equal to a second threshold, determine that there is no line of sight between the target device and the target object.

The first distance is the distance between the target device and the target object, or the first distance is a sum of the distance between the target device and the target object and a preset error value, or the first distance is a difference between the distance between the target device and the target object and a preset error value.

In some embodiments, the second threshold is a fixed value, or the second threshold is preconfigured, or the second threshold is configured by a network device.

In some embodiments, the processing unit 520 is specifically configured to:
determine, based on the first signal, whether there is a line of sight propagation path on a signal propagation route from the target device to the target object and then to the first device.

In some embodiments, the processing unit 520 is specifically configured to:
generate a distance-speed domain matrix based on the first signal; and
determine, based on the distance-speed domain matrix, a distance between the target device and the target object, and a distance between the first device and the target object, whether there is a line of sight propagation path on the signal propagation route from the target device to the target object and then to the first device.

In some embodiments, the processing unit 520 is specifically configured to:
in a case that there is an element whose value is greater than a third threshold in an element corresponding to a second distance in the distance-speed domain matrix, determine that there is a line of sight propagation path on the signal propagation route from the target device to the target object and then to the first device; and/or
in a case that there is no element whose value is greater than a third threshold in an element corresponding to a second distance in the distance-speed domain matrix, determine that there is no line of sight propagation path on the signal propagation route from the target device to the target object and then to the first device.

The second distance is a sum of D₁ and D₂, or the second distance is a sum of D₁, D₂, and a preset error value, or the second distance is a difference between a sum of D₁ and D₂ and a preset error value, where D₁ represents the distance between the target device and the target object, and D₂ represents the distance between the first device and the target object.

In some embodiments, the third threshold is a fixed value, or the third threshold is preconfigured, or the third threshold is configured by a network device.

In some embodiments, the processing unit 520 is specifically configured to:
generate channel response information based on the first signal; and
determine, based on the channel response information, a distance between the target device and the target object, and a distance between the first device and the target object, whether there is a line of sight propagation path on the signal propagation route from the target device to the target object and then to the first device.

In some embodiments, the processing unit 520 is specifically configured to:
in a case that a channel response value corresponding to a second distance in the channel response information is greater than a fourth threshold, determine that there is a line of sight propagation path on the signal propagation route from the target device to the target object and then to the first device; and/or
in a case that a channel response value corresponding to a second distance in the channel response information is less than or equal to a fourth threshold, determine that there is no line of sight propagation path on the signal propagation route from the target device to the target object and then to the first device.

The second distance is a sum of D₁ and D₂, or the second distance is a sum of D₁, D₂, and a preset error value, or the second distance is a difference between a sum of D₁ and D₂ and a preset error value, where D₁ represents the distance between the target device and the target object, and D₂ represents the distance between the first device and the target object.

In some embodiments, the fourth threshold is a fixed value, or the fourth threshold is preconfigured, or the fourth threshold is configured by a network device.

In some embodiments, the distance between the target device and the target object is determined by the first device based on location information of the target device and location information of the target object, or the distance between the target device and the target object is indicated by a first core network device to the first device, or the distance between the target device and the target object is determined based on measurement performed by the target device on a reference signal sent by the target object, or the distance between the target device and the target object is determined based on measurement performed by the target object on a reference signal sent by the target device; and/or
a distance between the first device and the target object is determined by the first device based on location information of the first device and location information of the target object, or the distance between the first device and the target object is indicated by a first core network device to the first device, or information about the distance between the first device and the target object is determined based on measurement performed by the first device on a reference signal sent by the target object, or information about the distance between the first device and the target object is determined based on measurement performed by the target object on a reference signal sent by the first device.

In some embodiments, the location information of the target device and the location information of the target object are indicated by the first core network device to the first device; and/or the location information of the first device and the location information of the target object are indicated by the first core network device to the first device; and/or
a configuration of the reference signal sent by the target device is indicated by the first core network device, or a configuration of the reference signal sent by the first device is indicated by the first core network device, or a configuration of the reference signal sent by the target object is indicated by the first core network device.

In some embodiments, the signal sent by the target device is sent by the target device based on information about an angle between the target device and the target object.

In some embodiments, the information about the angle between the target device and the target object is indicated by a first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device; and/or
a configuration of the reference signal sent by the target device is indicated by the first core network device, or a configuration of the reference signal sent by the target object is indicated by the first core network device.

In some embodiments, the communications unit 510 is further configured to send first information to a first core network device.

The first information is used to indicate whether there is a line of sight between the target device and the target object, or the first information is used to indicate whether there is a line of sight propagation path on a signal propagation route from the target device to the target object and then to the first device, or the first information is used to indicate whether the target device is allowed to be a sensing device of the target object.

In some embodiments, the first information includes at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

In some embodiments, the first core network device is an access and mobility management function AMF network element, or the first core network device is a sensing control network element.

In some embodiments, the first device is a terminal device, or the first device is a base station.

In some embodiments, the foregoing communications unit may be a communications interface or a transceiver, or an input/output interface of a communications chip or a system on chip. The foregoing processing unit may be one or more processors.

It should be understood that the wireless communications device 500 according to this embodiment of this application may correspond to the first device in the method embodiment of this application, and the foregoing and other operations and/or functions of the units in the wireless communications device 500 are separately used to implement corresponding processes of the first device in the method 200 shown in FIG. 4. For brevity, details are not described herein again.

FIG. 9 is a schematic block diagram of a wireless communications device 600 according to an embodiment of this application. The wireless communications device 600 is a first device. As shown in FIG. 9, the wireless communications device 600 includes:
a communications unit 610, configured to receive a first signal, where the first signal is an echo signal formed by reflecting a signal sent by a target device through a target object, and the target device is the first device or the target device is a device other than the first device; and
a processing unit 620, configured to generate second information based on the first signal, where the communications unit 610 is further configured to send the second information to a first core network device, where the second information is used by the first core network device to determine whether there is a line of sight between the target device and the target object, or the second information is used by the first core network device to determine whether there is a line of sight propagation path on a signal propagation route from the target device to the target object and then to the first device, or the second information is used by the first core network device to determine whether the target device is allowed to be a sensing device of the target object.

In some embodiments, the second information includes first channel information, and the first channel information includes at least one of following: A delay spread DS, an angular spread AS, a K factor, or a path loss.

In some embodiments, the second information includes at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

In some embodiments, the signal sent by the target device is sent by the target device based on information about an angle between the target device and the target object.

In some embodiments, the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device; and/or
a configuration of the reference signal sent by the target device is indicated by the first core network device, or a configuration of the reference signal sent by the target object is indicated by the first core network device.

In some embodiments, the first core network device is an access and mobility management function AMF network element, or the first core network device is a sensing control network element.

In some embodiments, the first device is a terminal device, or the first device is a base station.

In some embodiments, the foregoing communications unit may be a communications interface or a transceiver, or an input/output interface of a communications chip or a system on chip. The foregoing processing unit may be one or more processors.

It should be understood that the wireless communications device 600 according to this embodiment of this application may correspond to the first device in the method embodiment of this application, and the foregoing and other operations and/or functions of the units in the wireless communications device 600 are separately used to implement corresponding processes of the first device in the method 300 shown in FIG. 6. For brevity, details are not described herein again.

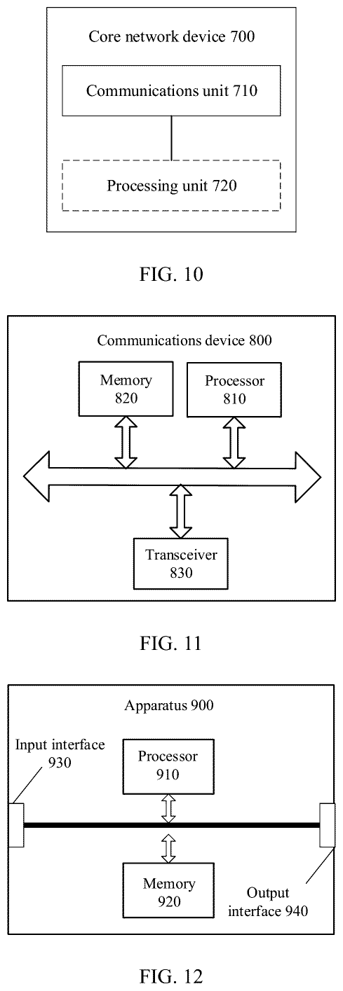

FIG. 10 is a schematic block diagram of a core network device 700 according to an embodiment of this application. The core network device 700 is a first core network device. As shown in FIG. 10, the core network device 700 includes:
a communications unit 710, configured to receive target information sent by a first device.

The target information is used to indicate whether there is a line of sight between a target device and a target object, or the target information is used to indicate whether there is a line of sight propagation path from a target device to a target object and then to the first device, or the target information is used to indicate whether a target device is allowed to be a sensing device of a target object; or
the target information is used by the first core network device to determine whether there is a line of sight between a target device and a target object, or the target information is used by the first core network device to determine whether there is a line of sight propagation path from a target device to a target object and then to the first device, or the target information is used by the first core network device to determine whether a target device is allowed to be a sensing device of a target object.

The target information is determined based on a first signal, the first signal is an echo signal formed by reflecting a signal sent by the target device through the target object, and the target device is the first device or the target device is a device other than the first device.

In some embodiments, the target information includes first channel information, and the first channel information includes at least one of following: A delay spread DS, an angular spread AS, a K factor, or a path loss.

In some embodiments, the target information includes at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

In some embodiments, the core network device 700 further includes:
a processing unit 720, configured to: determine, based on the target information, whether there is a line of sight between the target device and the target object, or determine, by the first core network device based on the target information, whether there is a line of sight propagation path from the target device to the target object and then to the first device, or determine, by the first core network device based on the target information, whether the target device is allowed to be a sensing device of the target object.

In some embodiments, the signal sent by the target device is sent by the target device based on information about an angle between the target device and the target object.

In some embodiments, the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

In some embodiments, the location information of the target device and the location information of the target object are indicated by the first core network device to the target device; and/or
a configuration of the reference signal sent by the target device is indicated by the first core network device, or a configuration of the reference signal sent by the target object is indicated by the first core network device.

In some embodiments, the first core network device is an access and mobility management function AMF network element, or the first core network device is a sensing control network element.

In some embodiments, the first device is a terminal device, or the first device is a base station.

In some embodiments, the foregoing communications unit may be a communications interface or a transceiver, or an input/output interface of a communications chip or a system on chip. The foregoing processing unit may be one or more processors.

It should be understood that the core network device 700 according to this embodiment of this application may correspond to the first core network device in the method embodiment of this application, and the foregoing and other operations and/or functions of the units in the core network device 700 are separately used to implement corresponding processes of the first core network device in the method 400 shown in FIG. 7. For brevity, details are not described herein again.

FIG. 11 is a schematic structural diagram of a communications device 800 according to an embodiment of this application. The communications device 800 shown in FIG. 11 includes a processor 810, and the processor 810 may invoke and run a computer program in a memory to implement a method in embodiments of this application.

In some embodiments, as shown in FIG. 11, the communications device 800 may further include a memory 820. The processor 810 may invoke and run a computer program in the memory 820 to implement a method in embodiments of this application.

The memory 820 may be a separate component independent of the processor 810, or may be integrated into the processor 810.

In some embodiments, as shown in FIG. 11, the communications device 800 may further include a transceiver 830. The processor 810 may control the transceiver 830 to communicate with another device, and specifically, may send information or data to the another device, or receive information or data sent by the another device.

The transceiver 830 may include a transmitter and a receiver. The transceiver 830 may further include an antenna, and there may be one or more antennas.

In some embodiments, the communications device 800 may be specifically the first device in embodiments of this application, and the communications device 800 may implement corresponding processes implemented by the first device in methods in embodiments of this application. For brevity, details are not described herein again.

In some embodiments, the communications device 800 may be specifically the first core network device in embodiments of this application, and the communications device 800 may implement corresponding processes implemented by the first core network device in methods in embodiments of this application. For brevity, details are not described herein again.

FIG. 12 is a schematic structural diagram of an apparatus according to an embodiment of this application. The apparatus 900 shown in FIG. 12 includes a processor 910, and the processor 910 may invoke and run a computer program in a memory to implement a method in embodiments of this application.

In some embodiments, as shown in FIG. 12, the apparatus 900 may further include a memory 920. The processor 910 may invoke and run a computer program in the memory 920 to implement a method in embodiments of this application.

The memory 920 may be a separate component independent of the processor 910, or may be integrated into the processor 910.

In some embodiments, the apparatus 900 may further include an input interface 930. The processor 910 may control the input interface 930 to communicate with another device or chip, and specifically, may obtain information or data sent by the another device or chip.

In some embodiments, the apparatus 900 may further include an output interface 940. The processor 910 may control the output interface 940 to communicate with another device or chip, and specifically, may output information or data to the another device or chip.

In some embodiments, the apparatus may be applied to the network device in embodiments of this application, and the apparatus may implement corresponding processes implemented by the network device in methods in embodiments of this application. For brevity, details are not described herein again.

In some embodiments, the apparatus may be applied to the first core network device in embodiments of this application, and the apparatus may implement corresponding processes implemented by the first core network device in methods in embodiments of this application. For brevity, details are not described herein again.

In some embodiments, the apparatus mentioned in embodiments of this application may alternatively be a chip, for example, may be a system-level chip, a system chip, a chip system, or a system-on-chip.

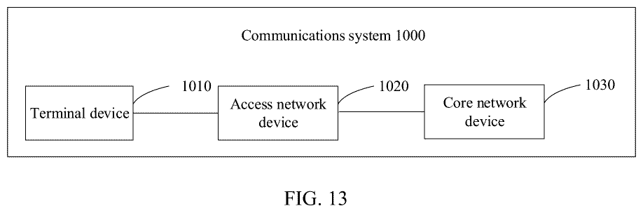

FIG. 13 is a schematic block diagram of a communications system 1000 according to an embodiment of this application. As shown in FIG. 13, the communications system 1000 includes a terminal device 1010, an access network device 1020, and a core network device 1030.

The terminal device 1010 may be configured to implement a corresponding function implemented by the terminal device in the foregoing method, the access network device 1020 may be configured to implement a corresponding function implemented by the base station in the foregoing method, and the core network device 1030 may be configured to implement a corresponding function implemented by the first core network device in the foregoing method. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor can implement or perform the methods, steps and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM). It should be noted that, the memory in the systems and methods described in this specification includes but is not limited to these memories and any memory of another proper type.

It should be understood that, by way of example but not limitative description, for example, the memory in this embodiment of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct Rambus random access memory (DR RAM), or the like. In other words, the memory in this embodiment of this application includes but is not limited to these memories and any memory of another proper type.

An embodiment of this application further provides a computer-readable storage medium, configured to store a computer program.

In some embodiments, the computer-readable storage medium may be applied to the core network device in embodiments of this application, and the computer program causes a computer to execute corresponding processes implemented by the first core network device in methods in embodiments of this application. For brevity, details are not described herein again.

In some embodiments, the computer-readable storage medium may be applied to the wireless communications device in embodiments of this application, and the computer program causes a computer to execute corresponding processes implemented by the first device in methods in embodiments of this application. For brevity, details are not described herein again.

An embodiment of this application further provides a computer program product, including computer program instructions.

In some embodiments, the computer program product may be applied to the core network device in embodiments of this application, and the computer program instructions cause a computer to execute corresponding processes implemented by the first core network device in methods in embodiments of this application. For brevity, details are not described herein again.

In some embodiments, the computer program product may be applied to the wireless communications device in embodiments of this application, and the computer program instructions cause a computer to execute corresponding processes implemented by the first device in methods in embodiments of this application. For brevity, details are not described herein again.

An embodiment of this application further provides a computer program.

In some embodiments, the computer program may be applied to the core network device in embodiments of this application, and the computer program, when run on a computer, causes the computer to execute corresponding processes implemented by the first core network device in methods in embodiments of this application. For brevity, details are not described herein again.

In some embodiments, the computer program may be applied to the wireless communications device in embodiments of this application, and the computer program, when run on a computer, causes the computer to execute corresponding processes implemented by the first device in methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art that may clearly understand that, for the purpose of convenient and brief description, for detailed working processes of the foregoing system, apparatus, and unit, reference may be made to a corresponding procedure in the foregoing method embodiments, and details are not described herein again.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. For such understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, comprising:
receiving, by a first device, a first signal, wherein the first signal is an echo signal formed by reflecting a signal sent by a target device through a target object, and the target device is the first device or the target device is a device other than the first device; and
determining, by the first device based on the first signal, whether there is a line of sight between the target device and the target object.

2. The method according to claim 1,
wherein in a case that the target device is a device other than the first device, the determining, by the first device based on the first signal, whether there is a line of sight between the target device and the target object comprises:
determining, by the first device based on the first signal, whether there is a line of sight propagation path on a signal propagation route from the target device to the target object and then to the first device.

3. The method according to claim 2, wherein the determining, by the first device based on the first signal, whether there is a line of sight propagation path on a signal propagation route from the target device to the target object and then to the first device comprises:
generating, by the first device, a distance-speed domain matrix based on the first signal; and
determining, by the first device based on the distance-speed domain matrix, a distance between the target device and the target object, and a distance between the first device and the target object, whether there is a line of sight propagation path on the signal propagation route from the target device to the target object and then to the first device.

4. The method according to claim 3,
wherein the determining, by the first device based on the distance-speed domain matrix, a distance between the target device and the target object, and a distance between the first device and the target object, whether there is a line of sight propagation path on the signal propagation route from the target device to the target object and then to the first device comprises:
in a case that there is an element whose value is greater than a third threshold in an element corresponding to a second distance in the distance-speed domain matrix, determining, by the first device, that there is a line of sight propagation path on the signal propagation route from the target device to the target object and then to the first device; and/or
in a case that there is no element whose value is greater than a third threshold in an element corresponding to a second distance in the distance-speed domain matrix, determining, by the first device, that there is no line of sight propagation path on the signal propagation route from the target device to the target object and then to the first device,
wherein the second distance is a sum of D1 and D2, or the second distance is a sum of D1, D2, and a preset error value, or the second distance is a difference between a sum of D1 and D2 and a preset error value, wherein D1 represents the distance between the target device and the target object, and D2 represents the distance between the first device and the target object; and
wherein the third threshold is a fixed value, or the third threshold is preconfigured, or the third threshold is configured by a network device.

5. The method according to claim 2, wherein the determining, by the first device based on the first signal, whether there is a line of sight propagation path on a signal propagation route from the target device to the target object and then to the first device comprises:
generating, by the first device, channel response information based on the first signal; and
determining, by the first device based on the channel response information, a distance between the target device and the target object, and a distance between the first device and the target object, whether there is a line of sight propagation path on the signal propagation route from the target device to the target object and then to the first device.

6. The method according to claim 5,
wherein the determining, by the first device based on the channel response information, a distance between the target device and the target object, and a distance between the first device and the target object, whether there is a line of sight propagation path on the signal propagation route from the target device to the target object and then to the first device comprises:
in a case that a channel response value corresponding to a second distance in the channel response information is greater than a fourth threshold, determining, by the first device, that there is a line of sight propagation path on the signal propagation route from the target device to the target object and then to the first device; and/or
in a case that a channel response value corresponding to a second distance in the channel response information is less than or equal to a fourth threshold, determining, by the first device, that there is no line of sight propagation path on the signal propagation route from the target device to the target object and then to the first device,
wherein the second distance is a sum of D1 and D2, or the second distance is a sum of D1, D2, and a preset error value, or the second distance is a difference between a sum of D1 and D2 and a preset error value, wherein D1 represents the distance between the target device and the target object, and D2 represents the distance between the first device and the target object; and
wherein the fourth threshold is a fixed value, or the fourth threshold is preconfigured, or the fourth threshold is configured by a network device.

7. The method according to claim 3,
wherein the distance between the target device and the target object is determined by the first device based on location information of the target device and location information of the target object, or the distance between the target device and the target object is indicated by a first core network device to the first device, or the distance between the target device and the target object is determined based on measurement performed by the target device on a reference signal sent by the target object, or the distance between the target device and the target object is determined based on measurement performed by the target object on a reference signal sent by the target device; and/or
a distance between the first device and the target object is determined by the first device based on location information of the first device and location information of the target object, or the distance between the first device and the target object is indicated by a first core network device to the first device, or information about the distance between the first device and the target object is determined based on measurement performed by the first device on a reference signal sent by the target object, or information about the distance between the first device and the target object is determined based on measurement performed by the target object on a reference signal sent by the first device.

8. The method according to claim 7, wherein the location information of the target device and the location information of the target object are indicated by the first core network device to the first device; and/or the location information of the first device and the location information of the target object are indicated by the first core network device to the first device; and/or
a configuration of the reference signal sent by the target device is indicated by the first core network device, or a configuration of the reference signal sent by the first device is indicated by the first core network device, or a configuration of the reference signal sent by the target object is indicated by the first core network device.

9. The method according to claim 1, wherein the signal sent by the target device is sent by the target device based on information about an angle between the target device and the target object.

10. The method according to claim 9,
wherein the information about the angle between the target device and the target object is indicated by a first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device; and
wherein the location information of the target device and the location information of the target object are indicated by the first core network device to the target device; and/or
a configuration of the reference signal sent by the target device is indicated by the first core network device, or a configuration of the reference signal sent by the target object is indicated by the first core network device.

11. The method according to claim 1, wherein the method further comprises:
sending, by the first device, first information to a first core network device,
wherein the first information is used to indicate whether there is a line of sight between the target device and the target object, or the first information is used to indicate whether there is a line of sight propagation path on a signal propagation route from the target device to the target object and then to the first device, or the first information is used to indicate whether the target device is allowed to be a sensing device of the target object.

12. The method according to claim 11,
wherein the first information comprises at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

13. A wireless communications device, wherein the wireless communications device is a first device, and the wireless communications device comprises a processor and a memory, wherein the memory is configured to store a computer program, and the processor is configured to invoke and run the computer program stored in the memory, to cause the wireless communications device at least to:
receive a first signal, wherein the first signal is an echo signal formed by reflecting a signal sent by a target device through a target object, and the target device is the first device or the target device is a device other than the first device; and
determine based on the first signal, whether there is a line of sight between the target device and the target object.

14. A core network device, wherein the core network device is a first core network device, and the core network device comprises a processor and a memory, wherein the memory is configured to store a computer program, and the processor is configured to invoke and run the computer program stored in the memory, to cause the core network device at least to:
receive target information sent by a first device,
wherein the target information is used to indicate whether there is a line of sight between a target device and a target object, or the target information is used to indicate whether there is a line of sight propagation path from a target device to a target object and then to the first device, or the target information is used to indicate whether a target device is allowed to be a sensing device of a target object; or
the target information is used by the first core network device to determine whether there is a line of sight between a target device and a target object, or the target information is used by the first core network device to determine whether there is a line of sight propagation path from a target device to a target object and then to the first device, or the target information is used by the first core network device to determine whether a target device is allowed to be a sensing device of a target object,
wherein the target information is determined based on a first signal, the first signal is an echo signal formed by reflecting a signal sent by the target device through the target object, and the target device is the first device or the target device is a device other than the first device.

15. The core network device according to claim 14, wherein the target information comprises first channel information, and the first channel information comprises at least one of following: a delay spread (DS), an angular spread (AS), a K factor, or a path loss.

16. The core network device according to claim 14, wherein the target information comprises at least one of following:
identity information of the first device, identity information of the target device, identity information of the signal sent by the target device, a distance-speed domain matrix generated based on the first signal, information, obtained based on the first signal, about a speed between the target device and the target object, or information, obtained based on the first signal, about a distance between the target device and the target object.

17. The core network device according to claim 14, wherein the signal sent by the target device is sent by the target device based on information about an angle between the target device and the target object.

18. The core network device according to claim 17,
wherein the information about the angle between the target device and the target object is indicated by the first core network device to the target device, or the information about the angle between the target device and the target object is determined by the target device based on location information of the target device and location information of the target object, or the information about the angle between the target device and the target object is determined based on measurement performed by the target device on a reference signal sent by the target object, or the information about the angle between the target device and the target object is determined based on measurement performed by the target object on a reference signal sent by the target device.

19. The core network device according to claim 18, wherein the location information of the target device and the location information of the target object are indicated by the first core network device to the target device; and/or
a configuration of the reference signal sent by the target device is indicated by the first core network device, or a configuration of the reference signal sent by the target object is indicated by the first core network device.

20. The core network device according to claim 14,
wherein the first core network device is an access and mobility management function (AMF) network element, or the first core network device is a sensing control network element.
